(19) United States
(12) Patent Application Publication
(10) Pub. No.: US 2007/0052663 A1
(43) Pub. Date: Mar. 8, 2007

(54) Liquid crystal display and method for lighting the same

(75) Inventors: Su-gun Kim, Hwaseong-si (KR); Tae-hee Cho, Seoul (KR); Ki-bum Seong, Anyang-si (KR); Jun-young Lee, Yongin-si (KR); Jung-hyeon Kim, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/514,271

(22) Filed: Sep. 1, 2006

(30) Foreign Application Priority Data
Sep. 5, 2005 (KR) 2005-0082193

(51) Int. Cl. G09G 3/36

(52) U.S. Cl. 345/102

(57) ABSTRACT

The present invention relates to an LCD and a method for improving display thereof where a plurality of LED devices are mounted on a rear of LCD panel, and a partition which allows the plurality of the LED devices to be disposed in a plurality of partitioned areas is provided. The thickness of the partition narrows toward the LCD panel. A power supplier supplies power to the plurality of LED devices, and a controller controls the power supplier to supply the power to the LED device in each divided area sequentially and repeatedly. An LCD with improved contrast ratio while LED devices are separately driven in a plurality of partitioned areas is achieved.

### CROSS-REFERENCE TO RELATED APPLICATIONS

This application claims the benefit under 35U.S.C. § 119of Korean Patent Application Serial No. 2005-0082193, filed on Sep.5, 2005, in the Korean Intellectual Property Office, the entire contents of which are hereby incorporated by reference.

### BACKGROUND OF THE INVENTION

1. Field of the Invention

The present invention relates to a liquid crystal display and a method of improving display thereof. More particularly, the present invention relates to a liquid crystal display and method providing improved contrast ratio while light emitting diode (LED) devices are respectively driven in a plurality of partitioned areas.

2. Description of the Related Art

Recently, flat panel display apparatuses, such as a liquid crystal display (LCD), a plasma display panel (PDP), and an organic light emitting diode (OLED), have been developed to substitute a conventional display such as a cathode ray tube (CRT).

An LCD comprises an LCD panel having a thin film transistor (TFT) substrate and a color filter substrate, and a liquid crystal disposed therebetween. Since the LCD panel does not emit light by itself, the LCD may comprise a backlight unit in the rear of the TFT substrate as a light source for providing light. The transmittance of the light emitted from the backlight unit is adjusted according to an alignment of the liquid crystal. The LCD panel and the backlight unit are accommodated in a chassis.

Depending on the location of the light source, the backlight unit may be an edge type or a direct type backlight unit. The edge type backlight unit provides the light source at a lateral side of a light guiding plate and is typically used for relatively small sized LCDs, such as those used in laptops and desktop computers. The edge type backlight unit provides the high light uniformity and good endurance, and is suitable for use in a thin profile LCDs.

As a result of increasing the size of the LCD panel in the market, the development of the direct type backlight unit has been emphasized. The direct type backlight unit enables to provide light on the entire surface of the LCD panel by disposing a plurality of light sources in the rear of the LCD panel. The direct type backlight unit provides a high level of brightness by using a plurality of light sources, as compared with the edge type backlight unit, but the brightness is generally not sufficiently uniform.

A conventional LED, which is a point light source, unlike a linear light source such as a lamp, has been recognized as a suitable light source for the direct type backlight unit. When the point light source is used, the backlight unit provides white light by mixing light of the point light sources having different colors.

A conventional method attempts to improve a display quality of a picture by lighting the light source corresponding to an input of a scanning signal of the LCD panel among driving methods of the backlight unit. However, a contrast ratio has low quality because the light of the partially lit light source influences adjacent parts.

### SUMMARY OF THE INVENTION

Accordingly, it is an exemplary object of the present invention to provide an LCD and a method for display where a good contrast ratio is achieved while LED devices are separately driven in a plurality of partitioned areas.

Additional features of exemplary embodiments of the present invention will be set forth in the description which follows, and in part will be apparent from the description, or may be learned by practice of the invention by artisans skilled in the art of LCDs.

The foregoing and/or other exemplary aspects of certain embodiments of the present invention can be achieved by providing an LCD device and method where an LCD panel has a plurality of LED devices mounted on a rear of the LCD panel, and a partition allows the plurality of the LED devices to be disposed in a plurality of partitioned areas. The thickness of the partition narrows toward the LCD panel. A power supplier supplies power to the plurality of LED devices, and a controller controls the power supplier to supply the power to the LED device in each divided area sequentially and repeatedly.

According to an exemplary aspect of the present invention, the partitioned areas comprise a rectangular shape, and can be arranged in parallel.

According to an exemplary aspect of the present invention, a size of the partitioned areas is regular.

According to an exemplary aspect of the present invention, the partition is arranged in a lattice shape.

According to an exemplary aspect of the present invention, a section of the partition comprises a triangular shape.

According to an exemplary aspect of the present invention, an internal angle of the section at a bottom side of the partition is between 70° and 85°.

According to an exemplary aspect of the present invention, a section of the partition comprises a trapezoid shape.

According to an exemplary aspect of the present invention, an internal angle of the section at a bottom side of the partition is between 70° and 85°.

According to an exemplary aspect of the present invention, a section of the partition comprises a stepped shape.

According to an exemplary aspect of the present invention, the LCD further comprises an LED circuit board mounted with the LED device, and a reflecting plate disposed on the LED circuit board while exposing the LED device. The partition can be integrated into the reflecting plate in a single body.

According to an exemplary aspect of the present invention, the partition is formed with a white color film.

According to an exemplary aspect of the present invention, the partition comprises at least one of polyethylene terephthalate (PET) and polycarbonate (PC).

It is to be understood that both the foregoing general description and the following detailed description are mere exemplary and provided to explain certain exemplary features of the present invention without limiting the scope thereof.

### BRIEF DESCRIPTION OF THE DRAWINGS

The above and/or other exemplary aspects and advantages of the prevent invention will become apparent and more readily appreciated from the following description of the exemplary embodiments, taken in conjunction with the accompany drawings, in which like reference numerals will be understood to refer to like parts, components and structures, where:

FIG. 1 is a block diagram of a liquid crystal display according to a first exemplary embodiment of the present invention;

FIG. 2 is a sectional view of the liquid crystal display according to the first exemplary embodiment of the present invention;

FIG. 3 is a perspective view of the liquid crystal display according to the first exemplary embodiment of the present invention;

FIG. 4 is a drawing for explaining a light path in the liquid crystal display according to the first exemplary embodiment of the present invention;

FIG. 5 is a drawing for explaining the brightness according to the partitioned area in liquid crystal display according to the first exemplary embodiment of the present invention;

FIGS. 6 and 7 are sectional views according to a second and a third exemplary embodiments of the present invention;

FIG. 8 is a perspective view of the liquid crystal display according to a fourth exemplary embodiment of the present invention;

FIG. 9 is a sectional view of the liquid crystal display according to the fourth exemplary embodiment of the present invention.

### DETAILED DESCRIPTION OF EXEMPLARY EMBODIMENTS

Reference will now be made in detail to certain embodiments of the present invention, examples of which are illustrated in the accompanying drawings, wherein as noted above like reference numerals refer to like elements throughout.

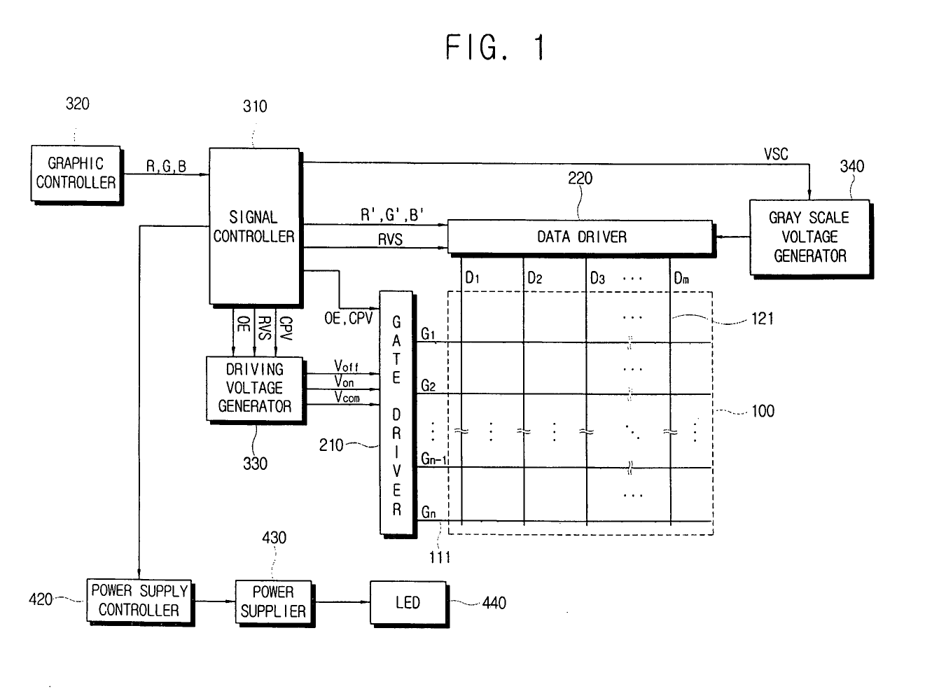

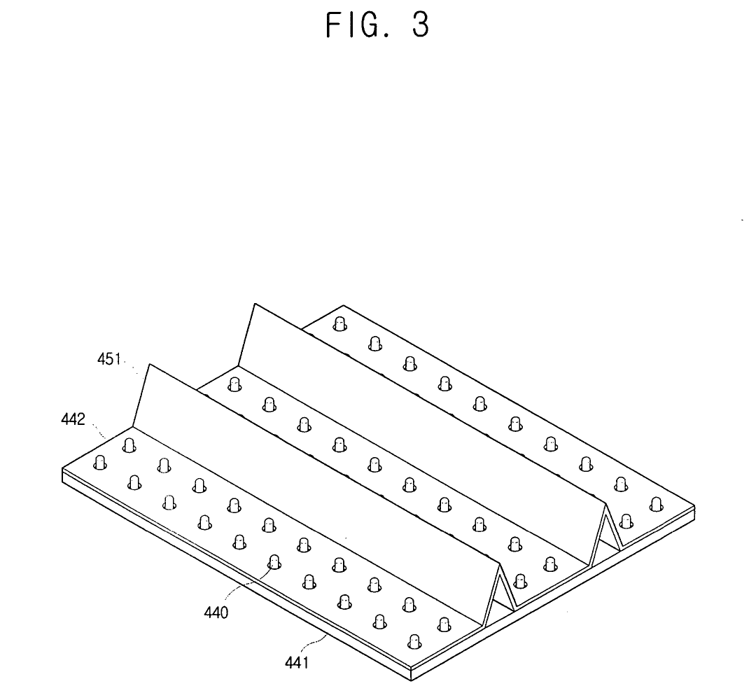

A liquid crystal display according to a first exemplary embodiment of the present invention will be described with reference to the FIGS. 1 through 3.

An LCD 1 of the present invention comprises an LCD panel 100, a gate driver 210 and a data driver 220 connected to the LCD panel 100, a driving voltage generator 330 connected to the gate driver 210 and a gray scale voltage generator 340 connected to the data driver 220, and a signal controller 310 which controls the above components and receives image data from a graphic controller 320. Light emitting diode (LED) devices 440 for providing light are arranged in a rear of the LCD panel 100. Also, a power supplier 430 supplying power to the LED device 440 and a power supply controller 420 controlling the power supplier 430 are provided in the LCD 1.

The LCD panel 100 comprises a color filter substrate 130 on which color filters are formed and a TFT substrate 110 on which TFTs are formed. A liquid crystal layer 141 is arranged in a space, for example, a cell gap, formed by the two substrates 130 and 110 and a sealant 131 arranged along edges of the two substrates 130 and 110.

The driving voltage generator 330 generates a gate on voltage Von turning-on the TFTs, a gate off voltage Voff turning-off the TFTs, and common electrode voltage Vcom to a common electrode and the like.

The gray scale voltage generator 340 generates a plurality of gray scale voltages related to the brightness of the LCD 1 and then supplies a gray scale voltage to the data driver 220.

The gate driver 210 which is alternatively referred to a scan driver is connected to a gate line 111 and then applies a gate signal comprising a combination of the gate on voltage Von and the gate off voltage Voff from the driving voltage generator 330 to the gate line 111.

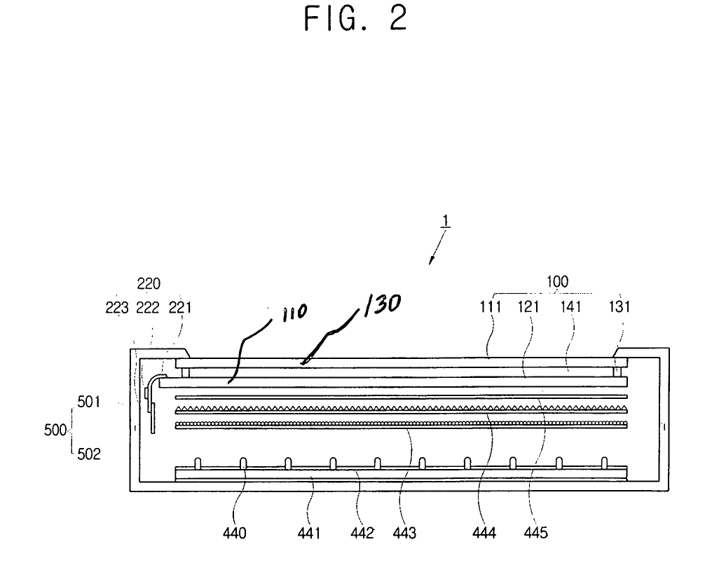

The gray scale voltage from the gray scale voltage generator 340 is applied to the data driver 220 which is alternatively referred to a source driver. The data driver 220 selects the gray scale voltage by a data line 121 provided on substrate 110 according to a control of the signal controller 310 and applies the gray scale voltage as a data signal to the data line 121. The data driver 220 comprises a flexible printed circuit (FPC) 221 of which a first side is connected to the TFT substrate 110, a driving chip 222 mounted on the FPC 221, and a printed circuit board (PCB) 223 connected on a second side of the FPC 221. Here, the data driver 220 shown in FIG. 2 is a chip on film (COF) type. However, other types of data drivers may be used, such as tape carrier package (TCP) or chip on glass (COG) type. Also, the gate driver 210 may be provided in the same manner as the data driver 220 and formed on the TFT substrate 110.

The signal controller 310 generates a control signal controlling operations of the gate driver 210, the data driver 220, the driving voltage generator 330 and the gray scale voltage generator 340 and the like and thus supplies the control signal with each of the gate driver 210, the data driver 220 and the driving voltage generator 330.

The LED devices 440, seated on the LED circuit board 441, are disposed across the entire rear surface of the LCD panel 100.

The reflecting plate 442 reflects the light generated from the LED devices 440 and directs the reflected light to the LCD panel 100. Portions of the reflecting plate 442 corresponding to where the LED devices 440 are arranged have been removed.

On the other hand, a partition 451 integrated into the reflecting plate 442 in a single body divides the LED devices 440 into three partitioned areas having the same size and a rectangular shape. The thickness of the partition 451 gets narrower toward an upper part, e.g., toward the LCD panel 100. A cross section of the partition 451 is a triangular shape. The partition 451 and the reflecting plate 442 is formed with a white color film and may comprise at least one of polyethylene terephthalate (PET) and polycarbonate (PC).

A diffusion sheet 443 comprises a base plate and a coating layer having beads formed on the base plate. If the light from the LED devices 440 is directly supplied to the LCD panel 100, a user recognizes an arrangement type of the LED devices 440. Accordingly, in order to improve brightness uniformity of the LCD 1, the diffusion sheet 443 evenly diffuses the light from the LED devices 440 and then supplies the light to the LCD panel 100.

A triangular prism is placed on a prism film 444 in alignment. The prism film 444 concentrates the light diffused from the diffusion sheet 443 in a direction perpendicular to a surface of the LCD panel 100. In an exemplary implementation, two prism films 444 are used, and the micro prisms formed on the prism film 444 form an angle each other. The light passing through the prism film 444 progresses vertically, thereby providing a uniform brightness distribution.

A protection film 445, positioned at the top of a light regulating part, protects the prism film 444 which is vulnerable to scratching.

A chassis 500 comprise an upper chassis 501 and a lower chassis 502 and accommodate the LCD panel 100 and the LED devices 440.

An operation of the LCD 1 is explained as follows.

The signal controller 310 is provided with RGB image data R, G, and B an input control signal controlling and a display of the image data from the graphic controller 320. For example, the input control signal comprises a vertical synchronizing signal Vsync, a horizontal synchronizing signal Hsync, a main clock CLK and a data enable signal DE an the like. The signal controller 310 generates a gate control signal, a data control signal and a voltage selection control signal VSC on the basis of the input control signal and adequately converts the RGB image data R, G, and B to correspond to an operational condition of the LCD panel 100. Thereupon, the gate control signal is transferred to the gate driver 210 and the driving voltage generator 330, and the data control signal and the processed RGB image data R, G, and B are outputted to the data driver 220. Also, the voltage selection control signal VSC is transferred to the gray scale voltage generator 340.

The gate control signal comprises a vertical synchronization start signal STV ordering a start of output of a gate on pulse (a high region of the gate signal), a gate clock signal CPV controlling output time of the gate on pulse and a gate on enable signal OE limiting the width of the gate on pulse. The gate on enable signal OE and the gate clock signal CPV among those are provided to the driving voltage generator 330. The data control signal comprises a horizontal synchronization start signal STH ordering a start of an input of a gray scale signal, a load signal LOAD or TP ordering an applying of the data voltage to the corresponding data line 121, a control reversion signal RVS reversing a polarity of the data voltage and a data clock signal HCLK and the like.

First, the gray scale voltage generator 340 provides the gray scale voltage having a voltage value determined by the voltage selection control signal VSC to the data driver 220.

The gate driver 210 applies the gate on voltage Von to the gate line 111, according to the gate control signal from the signal controller 310, in order. Thereby, the TFT connected to the gate line 111 is turned-on. At the same time, the data driver 220 provides an analog data voltage from the gray scale voltage generator 340 corresponding to an image data R′, G′ and B′ about a pixel comprising a turned-on switching device as the data signal to the corresponding data line 121 according to the data control signal from the signal controller 310.

The data signal provided in the data line 121 is applied to the corresponding pixel through a turned-on TFT. In this manner, the gate on voltage Von is applied to all the gate line 111 during one frame in turn and thus the data signal is applied to all the pixels. After the one frame, the control reversion signal RVS is provided to the driving voltage generator 330 and the data driver 220 and thus the polarities of all the data signals in next frame are changed.

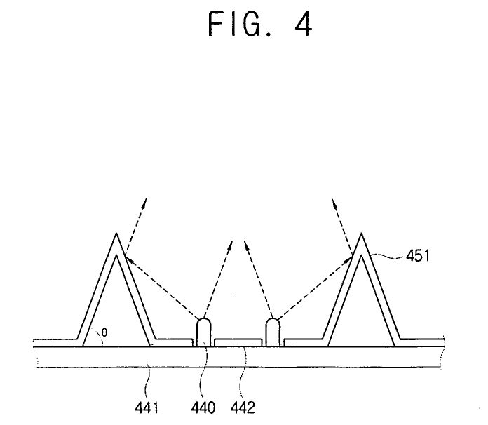

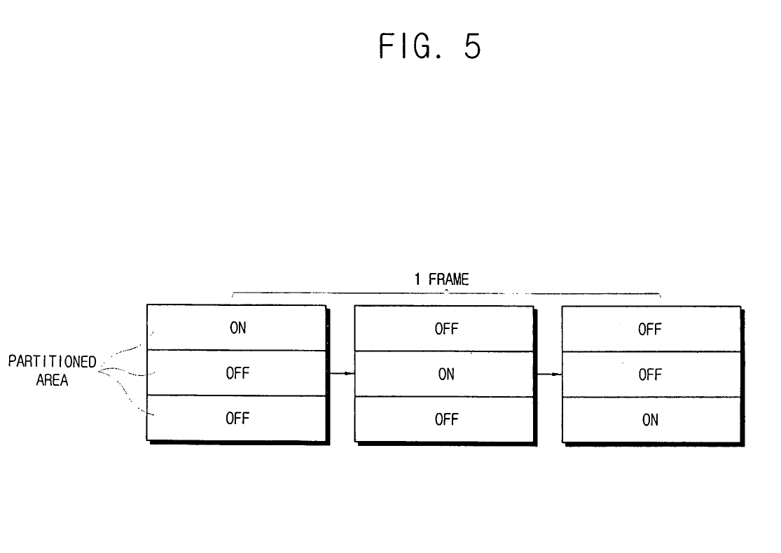

In first exemplary embodiment of the present invention, the LED device 440 is supplied with power according to the partitioned areas and thus brightness interference is decreased between the partitioned areas. Referring to FIGS. 4 and 5, an exemplary implementation is explained as follows.

FIG. 4 is a drawing for explaining a light path in the LCD 1 according to the first exemplary embodiment of the present invention. FIG. 5 is a drawing for explaining the brightness according to the partitioned area in the LCD 1 according to the first exemplary embodiment of the present invention.

A part of the light from the LED device 440 is radiated toward the upper part, for example, toward the LCD panel 100, and another part of the light from the LED device 440 is reflected by a side wall of the partition 451 and then is faced to the LCD panel 100.

Toward an upper part of the partition 451, the sectional area of the partition 451 narrows. Hereupon, an incident angle at which the light from the LED device 440 enters into the side wall of the partition 451 is larger and thus a total reflection occurs. In an exemplary implementation, an angle θ between the partition 451 and the LED circuit board 441 may be between 70° and 85°. Accordingly, the light from the LED device 440 has less influence on the brightness of other adjacent partitioned areas.

As shown in FIG. 5, since the power is provided to the LED device 440 by the partitioned areas sequentially and repeatedly, interference between the partitioned areas has been decreased.

If the sequentially driven LED device 440 radiates the light to the adjacent partitioned areas or the uniformity of the light is reduced, an overlap on or a spot of the screen may occur. According to the first exemplary embodiment of the present invention, since the interference between the adjacent partitioned areas has been decreased, the overlap on or the spot of the screen has been decreased. In addition, the contrast ratio has been improved and a motion blur has been decreased.

The first exemplary embodiment of the present invention may have various modifications and variation. For example, the number of the partitioned areas may be increased and time for supplying the power by the partitioned areas may be overlapped partially. In addition, the LED circuit board 441 may be divided and provided according to the respective partitioned areas.

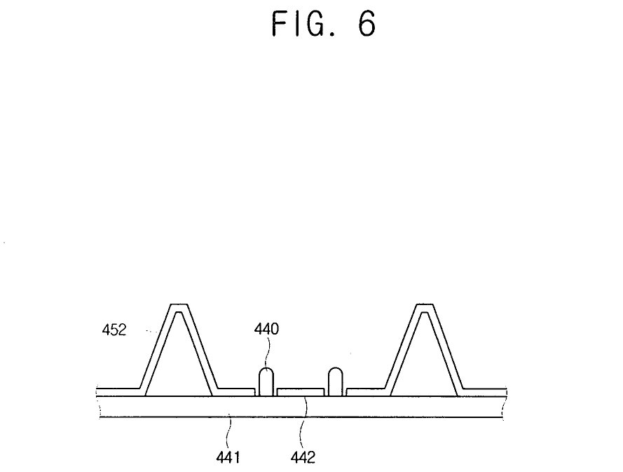

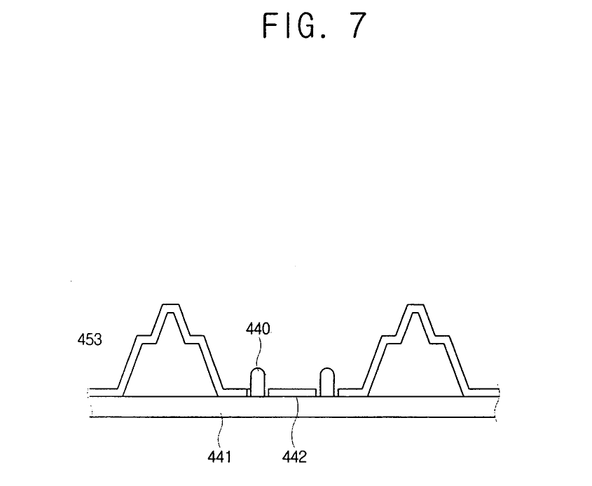

FIGS. 6 and 7 are sectional views of the LCD according to a second and a third embodiment of the present invention.

In the second exemplary embodiment of the present invention shown in FIG. 6, a section of the partition 452 is a trapezoid shape. The partition 452 is integrated into the reflecting plate 442 in a single body. In the third embodiment of the present invention shown in FIG. 7, the section of the partition 453 is a stepped shape. Also, the partition 453 is integrated into the reflecting plate 442.

The thickness of the partitions 452 and 453 according to the second and the third exemplary embodiments have been thinned toward the LCD panel 100 and thus the interferences between the partitioned areas have been decreased.

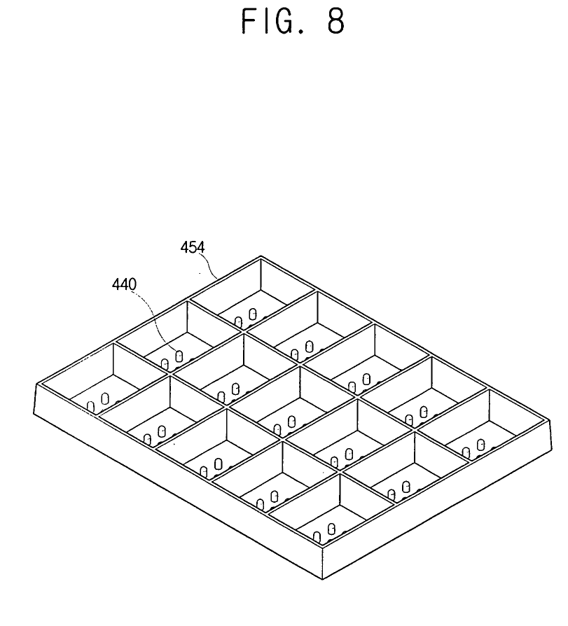

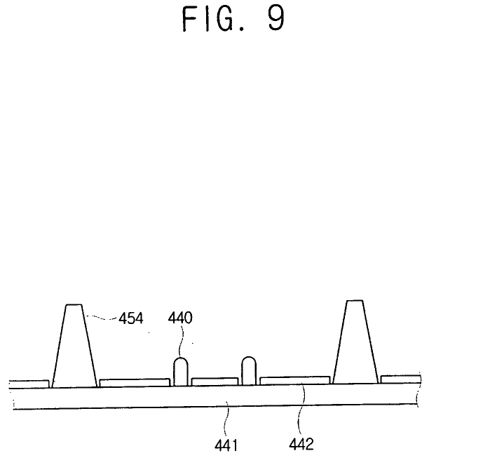

FIG. 8 is a perspective view of the LCD according to a fourth exemplary embodiment of the present invention. FIG. 9 is a sectional view of the LCD according to the fourth exemplary embodiment of the present invention.

A partition 454 according to the fourth exemplary embodiment of the present invention is provided so as not to integrate it into the reflecting plate 442. The thickness of the partition 454 has been thinned toward the LCD panel 100 and thus the interferences between the partitioned areas have been decreased. The partition 454 having a lattice shape divides the LED devices 440 to be disposed in the partitioned areas having a cross strip.

Although certain exemplary embodiments of the present invention have been shown and described, it will be apparent to those skilled in the art that various modifications and variation can be made in these embodiments without departing from the spirit of the invention the scope of which is defined in the appended claims and their equivalents.

1. A liquid crystal display (LCD), comprising:
an LCD panel;
a plurality of light emitting diode (LED) devices disposed in back of the LCD panel;
a partition which defines a plurality of partitioned areas, wherein at least one of the plurality of the LED devices is disposed in at least one of the plurality of the partitioned areas, the thickness of the partition get narrower toward the LCD panel;
a power supplier supplying power to at least one of the plurality of LED devices;
a controller controlling the power supplier to supply the power to at least one of the LED devices in at least one of the partitioned areas sequentially and repeatedly.

2. The LCD according to claim 1, wherein at least one of the partitioned areas comprises a rectangular shape, and the partitioned areas are arranged in parallel.

3. The LCD according to claim 1, wherein a size of the partitioned areas is regular.

4. The LCD according to claim 1, wherein the partition is arranged in a lattice shape.

5. The LCD according to claim 1, wherein at least a section of the partition comprises a triangular shape.

6. The LCD according to claim 5, wherein an internal angle of the section at a bottom side of the partition is between 70° and 85°.

7. The LCD according to claim 1, wherein at least a section of the partition comprises a trapezoid shape.

8. The LCD according to claim 7, wherein an internal angle of the section at a bottom side of the partition is between 70° and 85°.

9. The LCD according to claim 1, wherein at least a section of the partition comprises a stepped shape.

10. The LCD according to claim 1, further comprising:
an LED circuit board comprising at least one of the LED devices; and
a reflecting plate disposed on the LED circuit board and exposing at least one of the LED devices;
wherein the partition is integrated into the reflecting plate in a single body.

11. The LCD according to claim 1, wherein the partition comprises a white color film.

12. The LCD according to claim 1, wherein the partition comprises at least one of polyethylene terephthalate (PET) and polycarbonate (PC).

13. A method for lighting a liquid crystal display (LCD), comprising:
providing a plurality of light emitting diode (LED) in back of an LCD panel;
defining a plurality of partitioned areas, wherein at least one of the plurality of the LED devices is disposed in at least one of the plurality of the partitioned areas, by a partition of which thickness gets narrower toward the LCD panel; and
supplying power to the LED devices in each of the partitioned areas sequentially and repeatedly.

14. The method according to claim 13, wherein at least one of the partitioned areas comprises a rectangular shape, and the partitioned areas are arranged in parallel.

15. The method according to claim 13, wherein a size of the partitioned areas is regular.

16. The method according to claim 13, wherein the partition is arranged in a lattice shape.

17. The method according to claim 13, wherein at least a section of the partition comprises a triangular shape.

18. The method according to claim 17, wherein an internal angle of the section at a bottom side of the partition is between 70° and85°.

19. The method according to claim 13, wherein at least a section of the partition comprises a trapezoid shape.

20. The method according to claim 19, wherein an internal angle of the section at a bottom side of the partition is between 70° and 85°.

21. The method according to claim 13, wherein at least a section of the partition comprises a stepped shape.

22. The method according to claim 1, further comprising:
mounting at lest one of the LED devices on an LED circuit board; and
disposing a reflecting plate on the LED circuit board exposing at least one of the LED devices;
wherein the defining of the plurality of the partitioned areas comprises integrating the partition into the reflecting plate in a single body.

23. The method according to claim 13, wherein the partition comprises a white color film.
